(19) United States
(12) Patent Application Publication
(10) Pub. No.: US 2008/0071560 A1
(43) Pub. Date: Mar. 20, 2008

(54) VIDEO MARKETING SYSTEM FOR RESIDENTIAL NEW CONSTRUCTION

(76) Inventor: Linda M. Spencer, Southfield, MI (US)

Correspondence Address: Dickinson Wright PLLC, 38525 Woodward Avenue, Suite 2000, Bloomfield Hills, MI, 48304, US

(21) Appl. No.: 11/531,807

(22) Filed: Sep. 14, 2006

(51) Int. Cl. G06Q 10/00; G06Q 30/00

(52) U.S. Cl. 705/1

(57) ABSTRACT

A video marketing system for assisting in providing information to potential buyers on residential new construction. The method and system of the present invention include collecting and saving builder information on a computer regarding providers of residential new construction. A buyer queries the database, either directly or through a realtor, specifying certain criteria desired in their next residence. The system searches the database, identifies a builder that fulfills the buyer's criteria, and displays the identified builder. A service provider maintains the system and also provides other services to both the builders and the buyers utilizing the system. Video files providing virtual tours of the properties in the database are associated with each of the residential new construction.

### TECHNICAL FIELD

The present invention relates generally to a system for providing information to buyers of residential new construction. More particularly, the present invention relates to a video marketing system for providing information on residential new construction to buyers.

### BACKGROUND OF THE INVENTION

The purchase of residential property is a large investment for consumers. To assist consumers in this market there are known systems for identifying currently existing or previously owned homes that are for sale. One nationally recognized computer-automated system, the Multiple Listing Services (MLS), utilizes numbers to identify and describe the properties that are for sale. The MLS is for properties that are listed by real estate agents. Further, the MLS provides only limited information about residential listings to allow users or potential buyers to decide whether they are interested in the listing or whether to go visit the listed property or not. Often the MLS provides a photograph of the home, however, it is typically only of the exterior of the home and is usually only from one view of the property.

There are also consumers that choose to rent or lease residential property instead of purchasing. There are also known systems for assisting consumers in the market for leasing or renting apartments. These known systems also identify and describe the rental properties, but again only provide limited information. Again, if the consumer wants to see the property they typically must go visit the property for rent or lease.

However, there are no known systems for assisting buyers in the market to purchase new construction residential properties. Residential new construction includes new homes that have not previously been lived in. This is because these properties are not typically listed on the MLS as the builders sell them without real estate agents. In some instances, these homes are custom built to the specifications of a particular buyer otherwise they are newly constructed by the builder, but have not yet been sold.

It is difficult for buyers in the market for residential new construction to identify builders that offer homes that meet their desired criteria. Presently, people will drive around communities they are interested in to identify new neighborhoods or builders that are building in certain geographic areas. Even after identifying a particular builder that is building in a desired geographic area effort is still required to investigate the particular types of houses built by the identified builder. Another method of identifying builders is through word-of-mouth or recommendations of other people. Yet another method of identifying builders is by searching the Internet or World Wide Web of computers. These methods are inefficient and problematic because some builders do not maintain websites. Further, there is typically only limited information about the developments or homes being constructed by the builder. Therefore, there is a need for a centralized and easily accessible system for providing information to potential buyers on residential new construction. There is also a need to provide a system that allows potential buyers to view homes without having to go and visit the properties.

It is also problematic and expensive for builders to identify and market to potential buyers. Currently, it is the responsibility of individual builders to market their properties.

Therefore, there is a need for a system to assist buyers in the market for residential new construction properties by providing a consolidated source of information on builders as well as by providing more detailed information thereabout. Further, there is a need for a system to assist builders of new construction residential properties in identifying and marketing to potential buyers.

### SUMMARY OF THE INVENTION

It is therefore an advantage of the present invention to provide a centralized automated system that is maintained by a service provider containing a database of information on builders building residential new construction that is easily accessible and usable. The service provider also provides advertising services representing their associated builders to potential buyers in the market for residential new construction.

It is another advantage of the present invention to provide a video marketing system that helps builders of residential new construction provide more information about their properties accessible to potential buyers to allow them to make informed purchasing decisions.

It is a related advantage of the present invention to provide a video marketing system that provides information to potential buyers about residential new construction as well as the benefits of the community in which the new residential construction is located.

In accordance with the above and the other advantages, the present invention includes a database of builder information that contains information about builders as well as information about their residential new construction for easy access by potential buyers. The database allows a buyer to input specific criteria that they desire in a new residence. The database searches for new residences that meet the criteria entered by the potential buyer. For each new residence, the database contains information that is accessible by a potential buyer about the residential new construction uncovered by the search. For example, the database contains video files that are associated with head property of that allow the potential buyer to take a virtual tour of the home, including the home interior, the home exterior, and the property. The database also contains other information about each new residence, including special promotions or other specific information relating to either the builder or the residence being viewed.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is a schematic illustration of a system in accordance with an embodiment of the present invention;

FIG. 2 is a flowchart illustrating a method in accordance with an embodiment of the present invention; and

FIG. 3 is a flowchart illustrating a video marketing system in accordance with an embodiment of the present invention.

### DESCRIPTION OF PREFERRED EMBODIMENTS

In the following figures the same reference numerals will be used to refer to the same methods and components. Further, various operating parameters and components are described for the constructed embodiments. These specific parameters and components are included as examples and are not meant to be limiting. In accordance with one preferred embodiment, the present invention relates to a video marketing system that allows virtual home shopping for potential buyers, such as for residential home new construction.

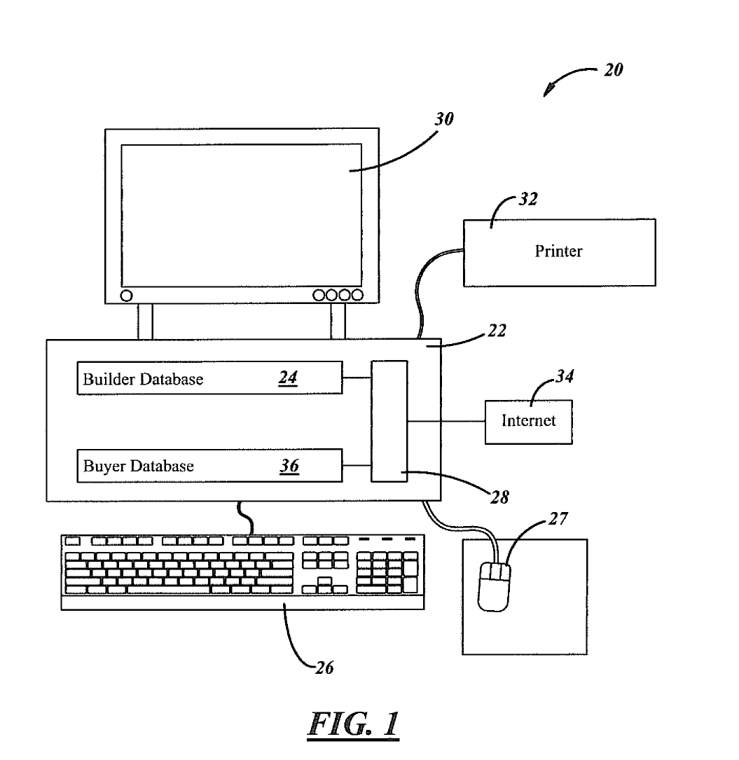

FIG. 1 illustrates one exemplary embodiment of a video marketing system 20 in accordance with the teachings of the present invention. The video marketing system, shown generally at 20, includes a computer 22 including a database of builder information 24 containing information on builders of residential new construction. A service provider maintains the video marketing system 20 and runs it for the benefit of the builders of residential new construction as well as buyers interested in purchasing same. It will be understood that the system 20 can be maintained and operated by a variety of other entities. The database of builder information 24 preferably contains information on builders of residential new construction. However, it will be understood that the builder database can contain information on other properties, such as previously owned homes and properties for rent or lease.

In accordance with one embodiment, there are numerous builders included in the database 24. For each builder, a variety of information is kept including, but not limited to, the builder's name, the community or neighborhood in which they are currently building new residential homes, information on the community or neighborhood, specific floor plans, total size of the house, number of bedrooms, number of bathrooms and the history and other general information of the builder. In accordance with one embodiment, video files that provide a virtual tour of each property are gathered and contained in the database and associated with each new construction, as discussed in more detail below. Additionally, in accordance with a preferred embodiment, the builders are required to pay a fee to be included in the program. Alternatively or in addition, the builders may be required to pay a commission to the service provider for any sales that originate with the system.

In accordance with one embodiment, the video marketing system 20 is preferably accessed by a potential buyer at the offices of the service provider, which maintains and operates the system 20, including updating the database and gathering or obtaining all the information contained therein. With this arrangement, the potential buyer can sit down with a consultant of the service provider and search the builder database 24 though a computer 22 located at the service provider's offices in order to find residential new home construction of interest. This allows potential buyers to access residential new home constructions in various cities and states from the computer 22. The consultant is also knowledgeable about both the system and the information contained in the database 24 such that the consultant can assist in the potential buyer in using the video marketing system 20 and accessing all the information on the database 24.

Buyers access the database 24 by inputting their desired criteria for their new home. The data is preferably entered via a keyboard 26 or a mouse 27. However, the data may be entered by other means as desired. The buyer criteria may include, but is not limited to, desired community, size of the house, number of bedrooms and number of bathrooms. The builder database 24 also preferably contains more detailed information on the communities within which the residential new construction is being built, for instance, local school information and property tax information, as discussed in more detail below. In the present invention, agents of the buyers, for example, realtors, may also access the database 24 on behalf of their clients. Again, for a realtor to obtain access to the database 24, they will typically have to pay a fee to the service provider. The software 28 executes on the computer 22 to search the database 24 and match the buyer criteria to a particular builder or builders. At the end of the execution, the results showing the matching builders are displayed. The results could be displayed and viewed on a monitor 30 or printed on a printer 32.

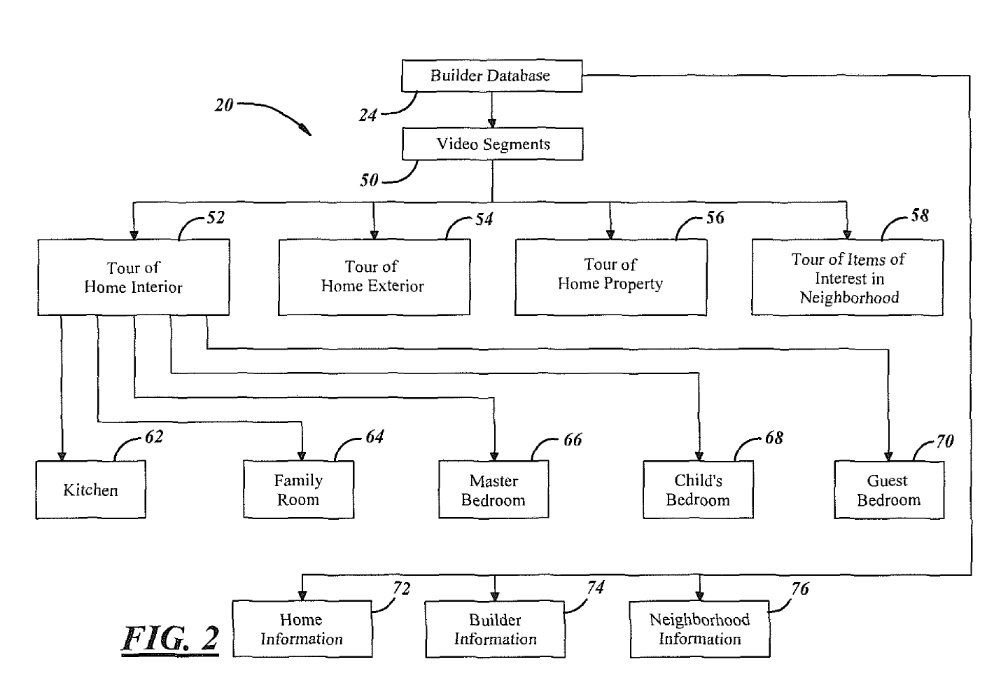

In accordance with one embodiment of the video marketing system 20, each of the new residential constructions contained in the database 24 has a variety of information associated therewith, which can be accessed by the potential buyer through links and the like. In one preferred embodiment, as shown in FIG. 2, the video marketing system 20 includes video segments 50 and other various information of possible interest to potential buyers relating to each property contained in the database 24. These items are accessible by the potential buyer for each property. For example, the video segments 50 include video consisting of a virtual tour of the interior of the home 52, a virtual tour of the exterior of the home 54, a virtual tour of property 56, and a virtual tour of items and places of interest in the neighborhood where the home is being built 58. Thus, when the database reveals a builder matching the buyer's criteria, the potential buyer can tour the entire home as well as the neighborhood and downtown without having to go and visit the home. This is particularly useful if the potential buyer is looking for new construction at various homes located in different parts of the same city or even in different states.

The video segments 50 are gathered by the service provider and are further subdivided. For example, the virtual tour of the interior of the home can provide a virtual tour of each of the rooms individually. For example, one video segment can be of the kitchen 62, the family room 64, the master bedroom 66, the child's bedroom 68, the guest bedroom 70, or the like. Obviously other or different rooms may also be the subject of individual video segments. It will be understood that the virtual tour of the exterior of the house as well as the entire property can be similarly subdivided into individual video segments to allow the potential buyers to tour each view of portion of the home or property as desired. The purpose of the video tours is to showcase the interior of a home, the exterior of a home, local area attractions and general information about the builder.

Additionally, the video marketing system 20 also includes other information about the homes 70, the builders 72, and the city or neighborhood 74 for the potential buyer. For example, the information about the city or neighborhood 74, includes information about the neighborhood where the home is being built that may be of interest to the potential buyer, such as information about the school district, weather, taxes, city services, etc. It will be understood that a variety of other information can also be accessible by the potential buyer as desired. Further, the information about the homes 70 provides information of interest to the potential buyer including information about special discounts, best prices, best promotions as well as other offers associated with the home. Again, it will be understood that other information may also be included about the homes. Additionally, the information about the builders 72 includes information about other homes or subdivisions construed by the builder, how long the builder has been constructing homes, and other information relevant to the builder to allow the potential buyer to make an informed purchasing decision.

As discussed above, the querying of the database of builders 24 can be performed at an office of the service provider. However, alternatively, it can be performed over the Internet or World Wide Web of computers 34 by connecting to the builder database 24 from a remote location. The system also allows for a buyer database 36 to be created. The system tracks the buyer criteria queries and this information is stored in the buyer database 36. Reports can be generated evaluating this data and distributed to the builders that are participating in the service. The builders can use this information for marketing purposes, such as to provide potential buyers with additional information about the home. The system 20 also allows reports to be generated analyzing the builder database.

The service provider also provides services to the buyers utilizing the system. One such benefit is that the service provider provides an interior decorating service to the buyers that purchase a home through the use of the service. Another service is that the service provider hosts contractor information sessions at the service provider's office. These information sessions are for informing the buyers about services offered by contractors they might be interested to include or install in their new homes. One example includes, but is not limited to, installing a swimming pool. Buyers are invited to attend these information sessions rather than individually contacting and scheduling sessions with contractors.

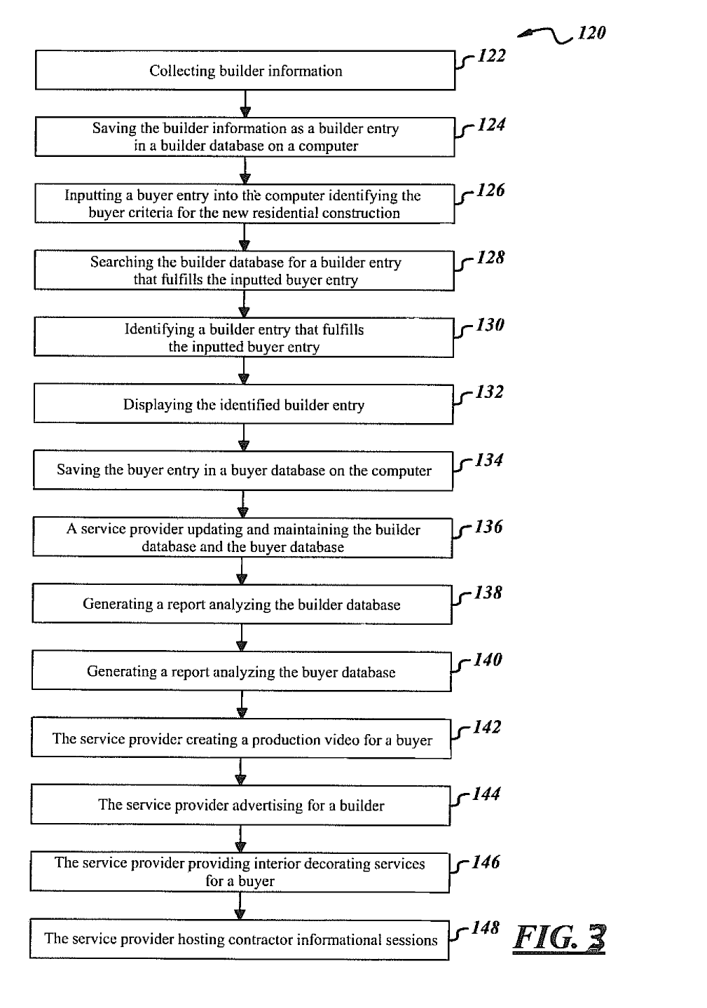

FIG. 3 illustrates a method, shown generally at 120, that is in accordance with an embodiment of the present invention. The method includes collecting builder information, at 122. This information is collected by the service provider. The builder information is saved as a builder entry in a builder database on a computer, at 124. A buyer entry is inputted into the computer identifying the buyer criteria for the new residential construction, at 126. The builder database is searched for a builder entry that fulfills the inputted buyer entry, at 128, and the builder entry that fulfills the inputted buyer entry is identified, at 130. The identified builder entry is displayed, at 132. The buyer entry is also saved in a buyer database on the computer, at 134. The service provider updates and maintains the builder and the buyer databases, at 136. Reports are also generated analyzing the builder database, at 138, and the buyer database, at 140.

The service provider also provides other services in addition to those listed above. For the builder, the service provider gathers information about each of the entities contained in the builders database 124, including creating a production video, at 142 for providing virtual tours of the interior of the home, the exterior of the home, the property and/or the neighborhood. The service provider also gathers detailed information about the neighborhood and advertises and markets the builder's services, at 144. For the buyer, the service provider provides interior decorating services, at 146, and also hosts contractor informational sessions, at 148.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A video marketing system for residential new construction, comprising:
a computer;
a database of builder information containing information on builders of residential new home construction for access by a potential buyer as well as information on each home from said builder;
at least one video segment associated with each builder for providing a virtual tour of each of said homes for access by said potential buyer and display on said computer.

2. The system of claim 1 wherein the system is maintained by a service provider and queried by a potential buyer.

3. The system of claim 2 wherein said database of builder information consists of builder name, builder general information, neighborhoods including new residential properties, floor plans offered, community information.

4. The system of claim 1 further comprising a database of buyer criteria.

5. The system of claim 4 wherein said database of buyer criteria consists of buyer name, numbers of family members, desired size of new construction residence and desired community of new construction residence.

6. The system of claim 5 further comprising generating reports utilizing the database of buyer criteria.

7. The system of claim 6 further comprising generating reports utilizing the database of builder information.

8. The system of claim 1, wherein system includes a video segment consisting of a virtual tour of the interior of the home and a video segment consisting of a virtual tour of the exterior of the home.

9. A system for providing services by a service provider relating to the sale of properties to potential buyers comprising:
a database including a listing of various properties;
an information component associated with each of said various properties in said database to provide information to a plurality of potential buyers; and
a video component associated with each of said various properties allowing said potential buyers to virtually tour at least portion of each of said various properties.

10. The system of claim 9, wherein said database is a database of residential new construction homes.

11. The system of claim 10, wherein said video component includes one or more of the following, a virtual tour of an interior of said property, or a virtual tour of an exterior of said property.

12. The system of claim 11, wherein said video component further includes a virtual tour of landmarks or areas of interest in a neighborhood in which said one of said various property is located.

13. A method of providing services relating to residential new construction comprising the steps:
collecting information about a plurality of builders of new construction and information on new construction homes built by each of said plurality of builders;
creating videos of at least portions of each of said new construction homes;
storing said information about said plurality of builders, said new construction homes, and said videos in a builder database;
allowing a potential buyer to search said builder database based on buyer input criteria;
displaying builder information from said database based on said buyer entered criteria; and
allowing buyers to take virtual tours of said at least portions of said new construction homes.

14. The method of claim 13 further comprising saving the buyer entry in a buyer database on an associate computer.

15. The method of claim 14 further comprising a service provider updating and maintaining the builder database and the buyer database.

16. The method of claim 15 further comprising:
generating a report analyzing the builder database; and
generating a report analyzing the buyer database.

17. The method of claim 16 further comprising the service provider providing interior decorating services for a buyer.

18. The method of claim 13 wherein said videos include at least one of the following:
a virtual tour of an interior of said new construction or a virtual tour of an exterior of said new construction.
